(19) United States
(12) Patent Application Publication
(10) Pub. No.: US 2006/0225282 A1
(43) Pub. Date: Oct. 12, 2006

(54) Manufacturing method of heat pipe

(75) Inventor: Chao-Tsai Chung, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/376,152

(22) Filed: Mar. 16, 2006

(30) Foreign Application Priority Data
Apr. 8, 2005 (TW) 94111191

(51) Int. Cl. B23P 6/00

(52) U.S. Cl. 29/890.032

(57) ABSTRACT

A manufacturing method of heat pipe is provided. First, a metal pipe is provided. Next, the metal pipe is shaped. Then, a metal inner layer having a capillary structure is formed at the internal wall of the metal pipe.

This application claims the benefit of Taiwan application Serial No. 094111191, filed Apr. 8, 2005, the subject matter of which is incorporated herein by reference.

### BACKGROUND OF THE INVENTION

1. Field of the Invention

The invention relates in general to a manufacturing method of heat pipe, and more particularly to a manufacturing method of heat pipe with metal inner layer having the capillary structure.

2. Description of the Related Art

Heat dissipation module, typically comprising a heat pipe, a fan and a heat exchanger, is applied in an electronic device to dissipate the heat. Referring to FIG. 1, a diagram illustrating the working of heat pipe is shown. The heat pipe 100 comprises a metal pipe 102, a metal inner layer 110 and a working fluid. The two ends of the metal pipe 102 are respectively referred to as an evaporating end 104 and a condensing end 106. The metal inner layer 110, which has a capillary structure, is formed at the internal wall of the metal pipe 102. The cavity 108 of the metal pipe 102 and the metal inner layer 110 are filled with the working fluid. The heat pipe 100 is able to transport heat by an evaporation-condensation cycle of the working fluid within porous metal inner layer 110.

When the heat pipe 100 dissipates the heat, the evaporating end 104 is close to the heat source, so that the working fluid at the evaporating end 104 absorbs the heat and vapors. Meanwhile, the pressure at the evaporating end 104 is higher than the pressure at the condensing end 106. Therefore, the vapor moves from the evaporating end 104 to the condensing end 106 in the cavity 108. When the vapor moves to the condensing end 106 of a lower temperature, it condenses and releases its latent heat of vaporization. The condensed working fluid is drawn back into the metal inner layer 110 and returns to the evaporating end 104. The capillary structure of the metal inner layer 110 provides the capillary driving force to return the condensed working fluid to the evaporating end 104. Accordingly, the heat pipe 100 is able to circulate the working fluid to dissipate the heat.

Referring to FIG. 2, a diagram of part of a conventional heat pipe after being shaped is shown. According to conventional manufacturing method of heat pipe, the metal inner layer 110 on the internal wall of the metal pipe 102 is formed before the metal pipe 102 is shaped. In the shaping procedure of the metal pipe 102, the metal inner layer 110 is extended or compressed (in the directions of the arrows in FIG. 2). The capillary structure of the metal inner layer 110 will be damaged in the procedure. Once the capillary structure cracks or deforms, the heat transport capability of the heat pipe will be decreased. To the worse of that, if the heat dissipation of the heat pipe is blocked and the working fluid will be dry out, resulting in malfunction of heat dissipation of the electronic device.

### SUMMARY OF THE INVENTION

An object of the invention provides a manufacturing method of heat pipe. At first, a metal pipe is shaped, and then a metal inner layer having a capillary structure is formed at the internal wall of the metal pipe, so that the capillary structure of the metal inner layer would not be cracked or deformed, thereby enhancing the heat dissipation effect of the heat pipe.

The embodiment of the invention provides a manufacturing method of heat pipe. Executing the deforming procedure shape a metal pipe. Then, a metal inner layer having a capillary structure is formed at the internal wall of the metal pipe.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram illustrating the working of heat pipe;

FIG. 2 is a diagram of part of a conventional heat pipe after being shaped.

FIG. 3 is a flowchart of a manufacturing method of heat pipe according to a first embodiment of the invention; and

FIG. 4 is a flowchart of a manufacturing method of heat pipe according to a second embodiment of the invention.

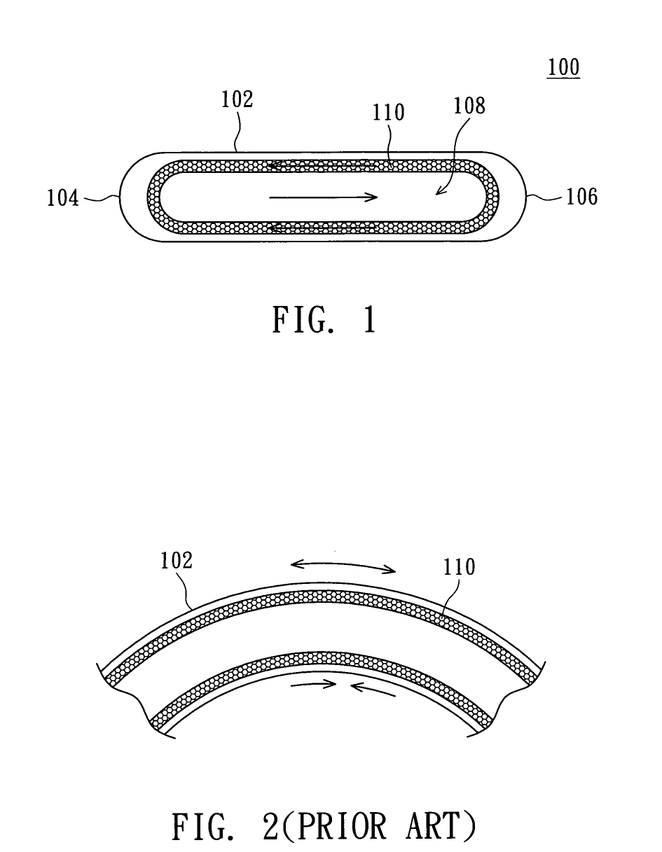

### DETAILED DESCRIPTION OF THE INVENTION

A metal pipe of the embodiment is shaped first, and then a metal inner layer having capillary structure is formed at the internal wall of the metal pipe. Thus, the capillary structure of the metal inner layer would not crack or deform since the metal pipe is shaped in the prior step for enhancing the heat dissipation effect of the heat pipe.

### First Embodiment

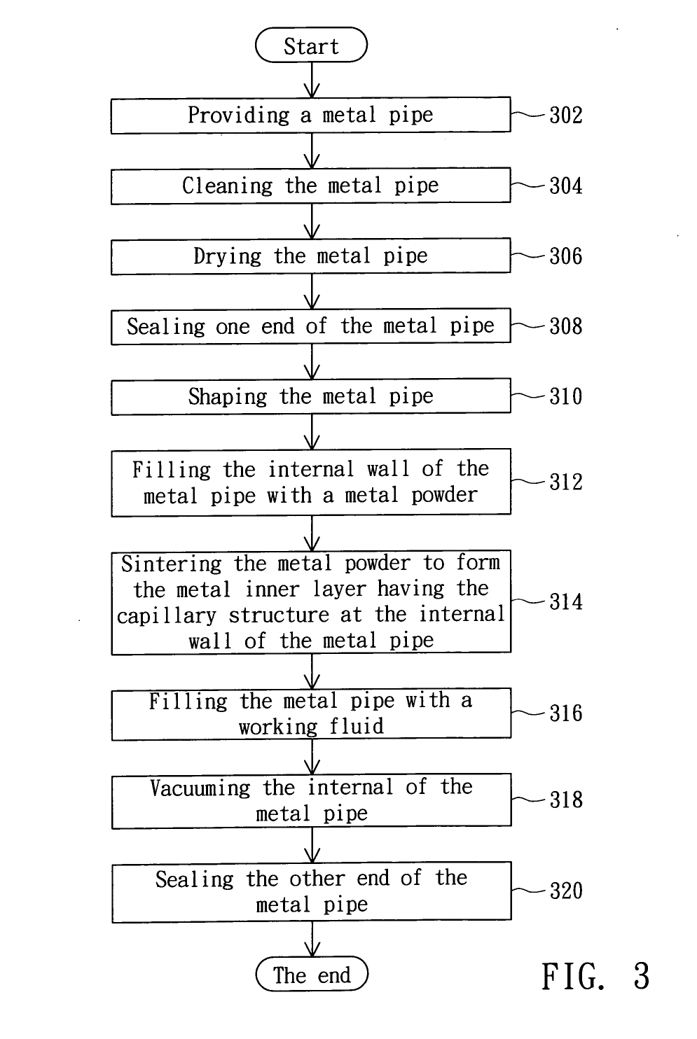

FIG. 3 is a flowchart of a manufacturing method of heat pipe according to a first embodiment of the invention. First, as shown in step 302, a metal pipe preferably made of copper is provided. Then, the metal pipe is cleaned and dried out as shown in step 304 and step 306. Next, one end of the metal pipe is sealed in step 308. As shown in step 310, bending or the like deforming procedures shape the metal pipe. After shaping the metal pipe, the metal powder put in the cavity of the metal pipe in step 312. The metal powder is made of copper for instance, and preferably spread over the internal wall of the metal pipe uniformly through a vibration. For example, the metal may be spread over one lateral side of the metal pipe. Then, as shown in step 314, the metal powder is sintered to form a metal inner layer having capillary structure. Moreover, as shown in step 316, a working fluid such as pure water or hydrotropic solution fills the metal pipe. Then, as shown in step 318, the metal pipe is vacuumed. Finally, as shown in step 320, another end of the metal pipe is sealed, so as to make the metal pipe to be leak-proof. Thus, the manufacturing method of heat pipe of the first embodiment according to the invention is completed.

### Second Embodiment

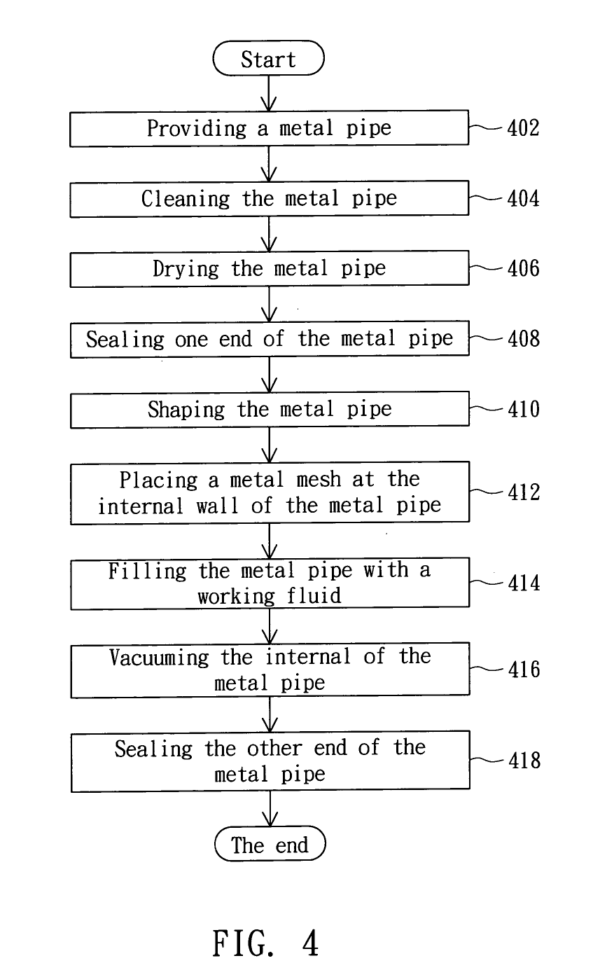

FIG. 4 is a flowchart of a manufacturing method of heat pipe according to a second embodiment of the invention. First, as shown in step 402, a metal pipe preferably made of copper is provided. Next, the metal pipe is cleaned and dried out as shown in step 404 and step 406. Then, one end of the metal pipe is sealed in step 408. Moreover, as shown in step 410, the metal pipe is shaped, by bending or the like deforming procedures. After shaping the metal pipe, a metal mesh is placed at the cavity of the metal pipe to form a metal inner layer having a capillary structure, as shown in step 412. The metal mesh is preferably made of copper. Moreover, as shown in step 414, a working fluid such as pure water or hydrotropic solution fills the metal pipe. Then, as shown in step 416, the metal pipe is vacuumed. Finally, as shown in step 418, another end of the metal pipe is sealed, so as to make the metal pipe to be leak-proof. Thus, the manufacturing method of heat pipe according to a second embodiment of the invention is completed.

According to the manufacturing method of heat pipe of the above embodiments, the metal pipe is shaped first, and then the metal inner layer having a capillary structure is formed at the cavity of the metal pipe. Therefore, the above embodiments of the manufacturing method of heat pipe effectively avoid the problem of the heat pipe manufactured by the conventional method. That is, the above embodiments keep the capillary structure uninjured, thereby enhancing the heat dissipation effect of the heat pipe. Besides, fewer heat pipes are required in the electronic device if each heat pipe has a great heat dissipation effect. Accordingly, if the heat pipes manufactured by the methods of the embodiments are applied in the electronic device, less space of the electronic device is occupied and the size of the electronic device can be further reduced, to accord with the current trend of slimness, lightweight and compactness of electronic device.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. For example, the metal inner layer of the invention is neither limited to the metal powder of the first embodiment nor the metal mesh of the second embodiment. Any materials capable of forming a capillary structure can be used a material for the metal inner layer of the invention. For example, metal inner layer having capillary structure can be formed by metal fiber.

What is claimed is:

1. A manufacturing method of heat pipe, comprising:
shaping a metal pipe; and
forming a metal inner layer at an internal wall of the shaped metal pipe, and the metal inner layer having a capillary structure.

2. The method according to claim 1, wherein after providing the metal pipe, the method further comprises:
cleaning the metal pipe;
drying the metal pipe; and
sealing one end of the metal pipe.

3. The method according to claim 1, wherein step of forming the metal inner layer on the metal pipe comprises:
putting a metal powder in the cavity of the metal pipe; and
sintering the metal powder to form the metal inner layer having the capillary structure at the internal wall of the metal pipe.

4. The method according to claim 3, wherein the metal powder is uniformly spread over the internal wall through a vibration method.

5. The method according to claim 3, wherein the metal powder is made of copper.

6. The method according to claim 1, wherein the metal pipe is made of copper.

7. The method according to claim 1, wherein the metal inner layer is made of copper.

8. The method according to claim 1, wherein step of forming the metal inner layer on the metal pipe comprises:
placing a metal mesh at the cavity of the metal pipe.

9. The method according to claim 8, wherein the metal mesh is made of copper.

10. The method according to claim 2, wherein after the step of forming the metal inner layer on the metal pipe, the method further comprises:
filling the metal pipe with a working fluid;
vacuuming the internal of the metal pipe; and
sealing the other end of the metal pipe.

11. The method according to claim 10, wherein the working fluid is substantially water.

12. The method according to claim 1, wherein the metal inner layer is a metal fiber.

13. The method according to claim 12, wherein the metal fiber is made of copper.
